(19) United States
(12) Patent Application Publication
(10) Pub. No.: US 2024/0353560 A1
(43) Pub. Date: Oct. 24, 2024

(54) OBJECT DETECTING DEVICE, OBJECT DETECTING SYSTEM, AND OBJECT DETECTING METHOD

(71) Applicant: NEC Corporation, Minato-ku, Tokyo (JP)

(72) Inventor: Kan KIMURA, Tokyo (JP)

(73) Assignee: NEC Corporation, Minato-ku, Tokyo (JP)

(21) Appl. No.: 18/580,661

(22) PCT Filed: Jul. 28, 2021
(86) PCT No.: PCT/JP2021/027822

§ 371 Date: Jan. 19, 2024

(51) Int. Cl. G01S 17/26; G01S 7/484; G01S 7/4861

(52) U.S. Cl. CPC G01S 17/26; G01S 7/484; G01S 7/4861

(57) ABSTRACT

An object detecting device includes: a modulator configured to execute modulation processing of converting an analog waveform of a transmission wave being sent toward an object by a transmission/reception device into a first analog waveform being an analog waveform associated with a predetermined digital code string; a pulse compressor configured to execute, by using the first analog waveform, pulse compression processing on a second analog waveform being an analog waveform of a reception wave reflected by the object and received by the transmission/reception device; and a distance estimator configured to estimate a distance between the transmission/reception device and the object, based on a result of the pulse compression processing.

### TECHNICAL FIELD

The present invention relates to an object detecting device and the like.

### BACKGROUND ART

A radar device that measures a distance to an object by employing a time-of-flight (ToF) method is known. Also known is a light detection and ranging (LiDAR) device that measures a distance to an object by the ToF method. Herein, when two objects are arranged in proximity to each other in a depth direction (i.e., “line-of-sight direction”), that is, when a distance from the radar device or the LiDAR device to each of the two objects is a close value, radio waves or light reflected by the two objects may be received in a state of being overlapped with each other. In such a case, in the ToF method, there is a problem that it is difficult to detect the two objects separately.

With regard to such a problem, a technique of separating and detecting two objects by using digital pulse compression is known (for example, see PTL 1). PTL 1 discloses a radar device using digital pulse compression (in particular, see paragraphs to [0056], to [0080], [0101]to [0125], FIGS. 1, 3, and 5 of PTL 1).

### CITATION LIST

### Patent Literature

PTL 1: International Patent Publication No. WO2012/140859

### SUMMARY OF INVENTION

### Technical Problem

In a case where digital pulse compression is used as in the technique described in PTL 1, distance resolution is degraded due to encoding as compared with a case where a conventional ToF method is used. Specifically, it is assumed that a distance associated with a length of each symbol when encoding a waveform of a transmitted radio wave or light is d and the speed of light is c. At this time, there is a problem that the distance resolution is limited by a value of d×c. In other words, there is a problem that the distance resolution is degraded according to the value of d×c.

In view of the above-described problem, an objective of the present invention is to improve distance resolution when separating and detecting a plurality of objects arranged in proximity to one another in a line-of-sight direction.

### Solution to Problem

An object detecting device according to the present invention includes: a modulation means for executing modulation processing of converting an analog waveform of a transmission wave being sent toward an object by a transmission/reception device into a first analog waveform being an analog waveform associated with a predetermined digital code string: a pulse compression means for executing, by using the first analog waveform, pulse compression processing on a second analog waveform being an analog waveform of a reception wave reflected by the object and received by the transmission/reception device: and a distance estimation means for estimating a distance between the transmission/reception device and the object, based on a result of the pulse compression processing.

An object detecting system according to the present invention includes: a modulation means for executing modulation processing of converting an analog waveform of a transmission wave being sent toward an object by a transmission/reception device into a first analog waveform being an analog waveform associated with a predetermined digital code string: a pulse compression means for executing, by using the first analog waveform, pulse compression processing on a second analog waveform being an analog waveform of a reception wave reflected by the object and received by the transmission/reception device; and a distance estimation means for estimating a distance between the transmission/reception device and the object, based on a result of the pulse compression processing.

An object detecting method according to the present invention includes: executing, by a modulation means, modulation processing of converting an analog waveform of a transmission wave being sent toward an object by a transmission/reception device into a first analog waveform being an analog waveform associated with a predetermined digital code string: executing, by a pulse compression means by using the first analog waveform, pulse compression processing on a second analog waveform being an analog waveform of a reception wave reflected by the object and received by the transmission/reception device; and estimating, by a distance estimation means, a distance between the transmission/reception device and the object, based on a result of the pulse compression processing.

### Advantageous Effects of Invention

According to the present invention, distance resolution can be improved when separating and detecting a plurality of objects arranged in proximity to one another in a line-of-sight direction.

### BRIEF DESCRIPTION OF DRAWINGS

FIG. 1 is a block diagram illustrating an object detecting system according to a first example embodiment.

FIG. 2 is a block diagram illustrating a hardware configuration of an object detecting device according to the first example embodiment.

FIG. 3 is a block diagram illustrating another hardware configuration of the object detecting device according to the first example embodiment.

FIG. 4 is a block diagram illustrating another hardware configuration of the object detecting device according to the first example embodiment.

FIG. 5 is a flowchart illustrating an operation of the object detecting device according to the first example embodiment.

FIG. 6A is an explanatory diagram illustrating an example of an analog waveform of a transmission signal before modulation.

FIG. 6B is an explanatory diagram illustrating an example of an analog waveform (first analog waveform) of a modulated transmission signal.

FIG. 7A is an explanatory diagram illustrating an example of an analog waveform (first analog waveform) of a modulated transmission signal.

FIG. 7B is an explanatory diagram illustrating an example of an autocorrelation function waveform of the first analog waveform.

FIG. 8A is an explanatory diagram illustrating an example of an analog waveform of a first reflected wave.

FIG. 8B is an explanatory diagram illustrating an example of an analog waveform of a second reflected wave.

FIG. 8C is an explanatory diagram illustrating an example of an analog waveform (second analog waveform) of a reception wave.

FIG. 8D is an explanatory diagram illustrating an example of an analog waveform of the first reflected wave, an analog waveform of the second reflected wave, and an analog waveform (second analog waveform) of the reception wave.

FIG. 8E is an explanatory diagram illustrating an example of an analog pulse compression waveform.

FIG. 9A is an explanatory diagram illustrating an example of object detection executed by a comparative object detecting system.

FIG. 9B is an explanatory diagram illustrating an example of object detection executed by a comparative object detecting system.

FIG. 9C is an explanatory diagram illustrating an example of object detection executed by a comparative object detecting system.

FIG. 10A is an explanatory diagram illustrating an example of object detection executed by the object detecting system according to the first example embodiment.

FIG. 10B is an explanatory diagram illustrating an example of object detection executed by the object detecting system according to the first example embodiment.

FIG. 10C is an explanatory diagram illustrating an example of object detection executed by the object detecting system according to the first example embodiment.

FIG. 10D is an explanatory diagram illustrating an example of object detection executed by the object detecting system according to the first example embodiment.

FIG. 11 is a block diagram illustrating an object detecting system according to a second example embodiment.

FIG. 12 is a flowchart illustrating an operation of the object detecting device according to the second example embodiment.

FIG. 13A is an explanatory diagram illustrating an example of an analog waveform (first analog waveform) of a modulated transmission signal.

FIG. 13B is an explanatory diagram illustrating an example of an autocorrelation function waveform of the first analog waveform.

FIG. 14 is a block diagram illustrating an object detecting device according to a third example embodiment.

FIG. 15 is a block diagram illustrating an object detecting system according to the third example embodiment.

### EXAMPLE EMBODIMENT

Hereinafter, example embodiments of the present invention will be described in detail with reference to the accompanying drawings.

### First Example Embodiment

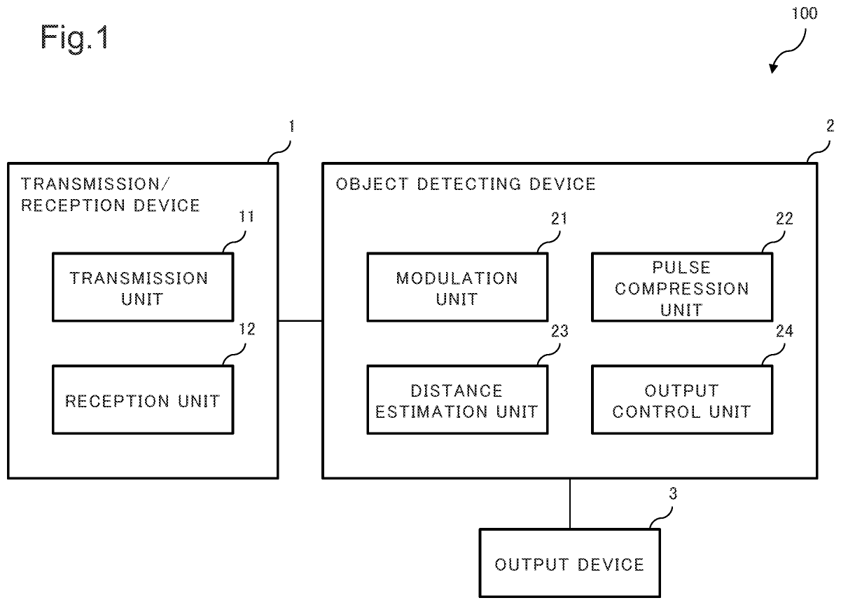

FIG. 1 is a block diagram illustrating an object detecting system according to a first example embodiment. The object detecting system according to the first example embodiment is described with reference to FIG. 1.

As illustrated in FIG. 1, an object detecting system 100 includes a transmission/reception device 1, an object detecting device 2, and an output device 3. The transmission/reception device 1 and the object detecting device 2 are connected to each other by wireless or wired communication. The object detecting device 2 and the output device 3 are connected to each other by wireless or wired communication.

The transmission/reception device 1 is a device that transmits and receives a wave for ranging (hereinafter, may be referred to as a [ranging The transmission/reception device 1 may include, for example, wave]). a radar device or a LIDAR device. That is, the ranging wave may be, for example, radio waves or light beams. Hereinafter, the ranging wave transmitted by the transmission/reception device 1 may be referred to as a [transmission wave]. Further, the ranging wave received by the transmission/reception device 1 may be referred to as a [reception wave]. A signal associated with the transmission wave may be referred to as a [transmission signal]. Further, a signal associated with the reception wave may be referred to as a [reception signal].

The transmission/reception device 1 includes a transmission unit 11 and a reception unit 12. The transmission unit 11 emits a transmission wave associated with a transmission signal modulated by a modulation unit 21 described later. The transmission wave is constituted of, for example, a millimeter wave or laser light. The emitted transmission wave is irradiated onto each object (hereinafter, may be referred to as an [object]) to be detected by the object detecting system 100. The emitted transmission wave is reflected by each object. The reception unit 12 receives a backscattered component of the reflected transmission wave (hereinafter, may be referred to as a [reflected wave]). That is, the backscattered component of the reflected wave becomes the reception wave. As a result, the reception signal is acquired.

The object detecting device 2 is a device that detects each object by estimating a distance D from the transmission/reception device 1 to each of the objects. The object detecting device 2 includes the modulation unit 21, a pulse compression unit 22, a distance estimation unit 23, and an output control unit 24.

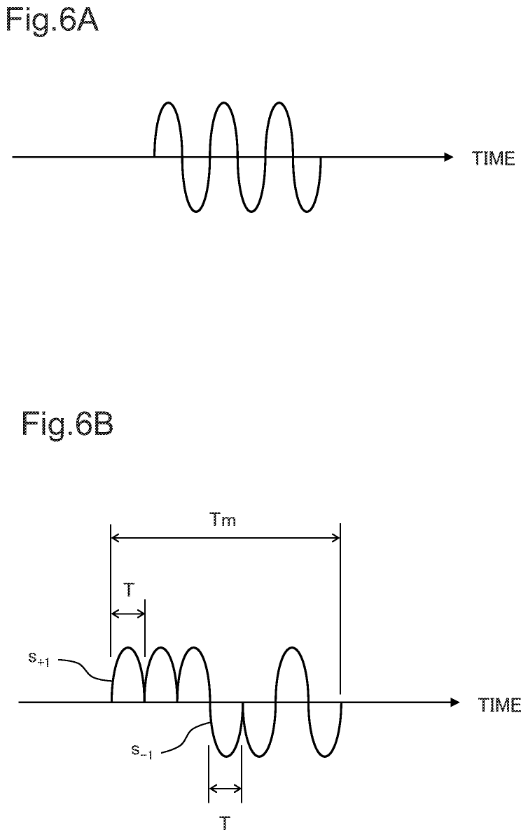

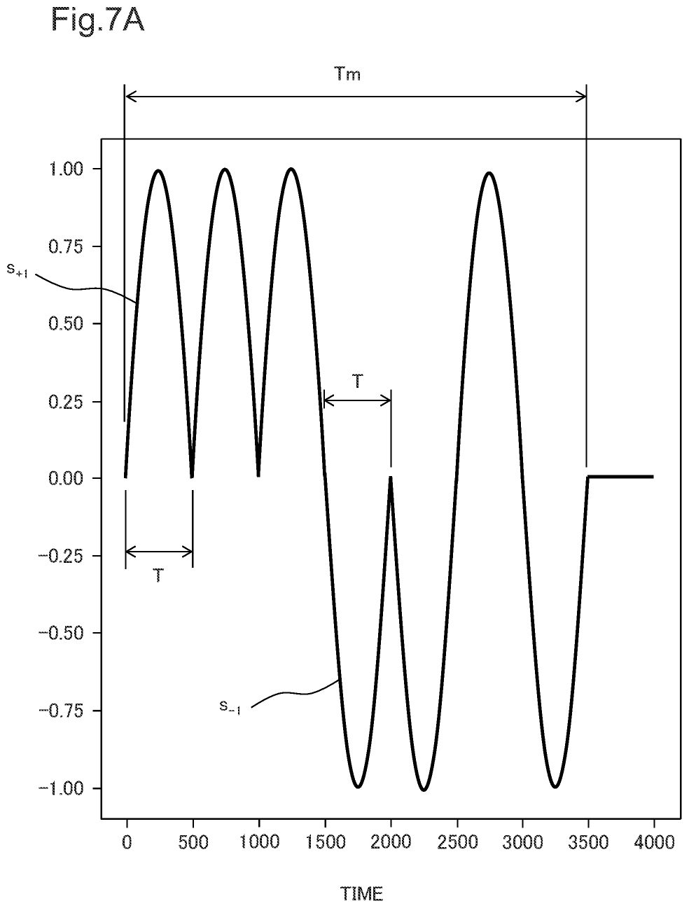

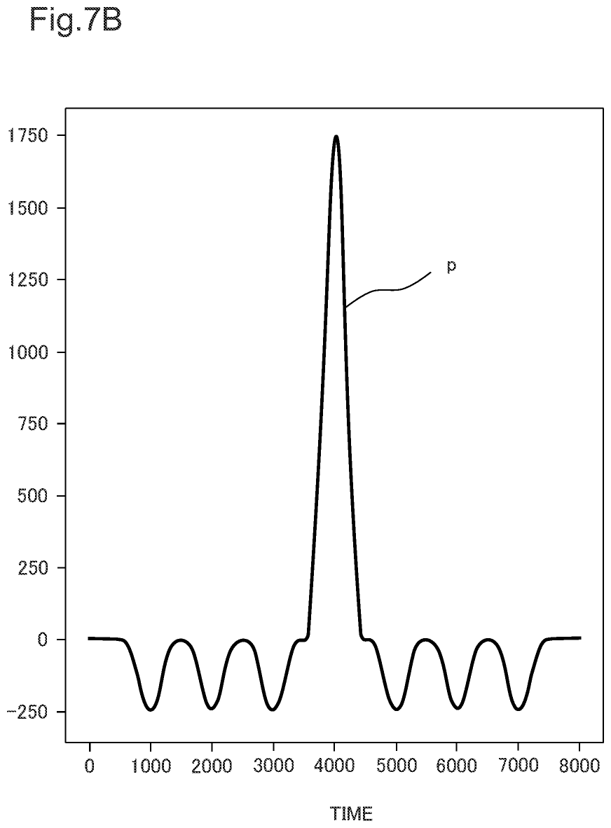

The modulation unit 21 executes modulation processing on the transmission signal. Herein, the modulation processing executed by the modulation unit 21 is modulation processing of converting an analog waveform of the transmission wave (i.e., an analog waveform of the transmission signal) into an analog waveform associated with a predetermined digital code string (hereinafter, may be referred to as [first analog waveform]). That is, the modulation unit 21 executes modulation processing of converting the analog waveform of the transmission signal into the first analog waveform. As described above, the transmission wave is sent toward the object by the transmission/reception device 1. In the first example embodiment, the predetermined digital code string includes binary codes using two values which are [−1] and [+1]. Specifically, for example, the predetermined digital code string uses a Barker code of N=7. Herein, N is a code length. A specific example of the modulation processing and a specific example of the first analog waveform are described later with reference to FIGS. 6A, 6B, 7A, and 7B.

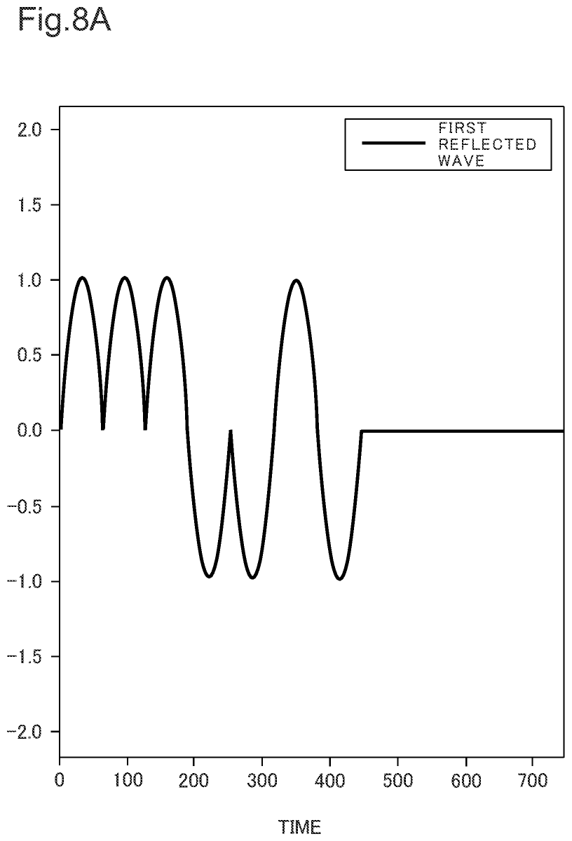

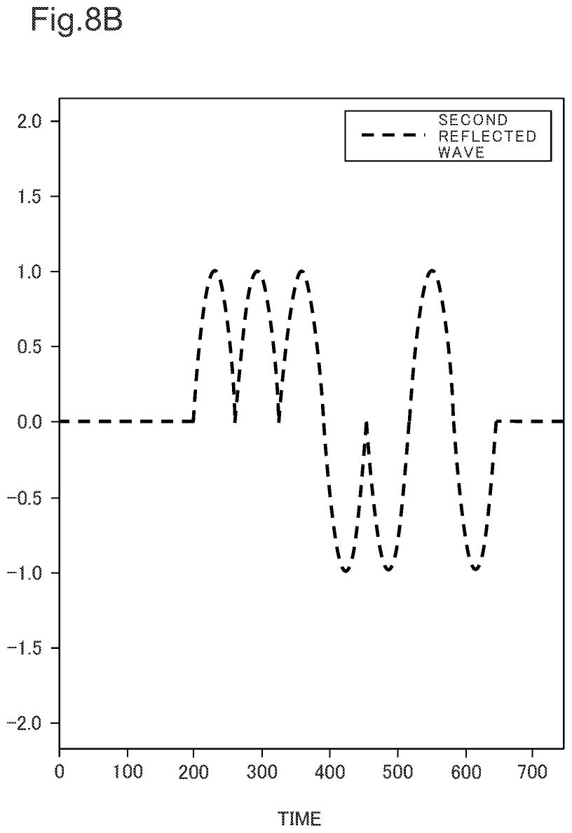

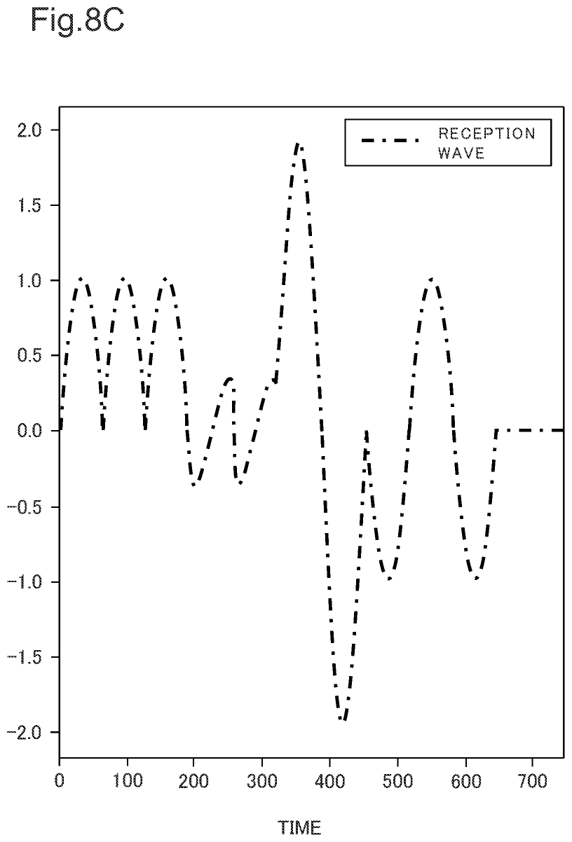

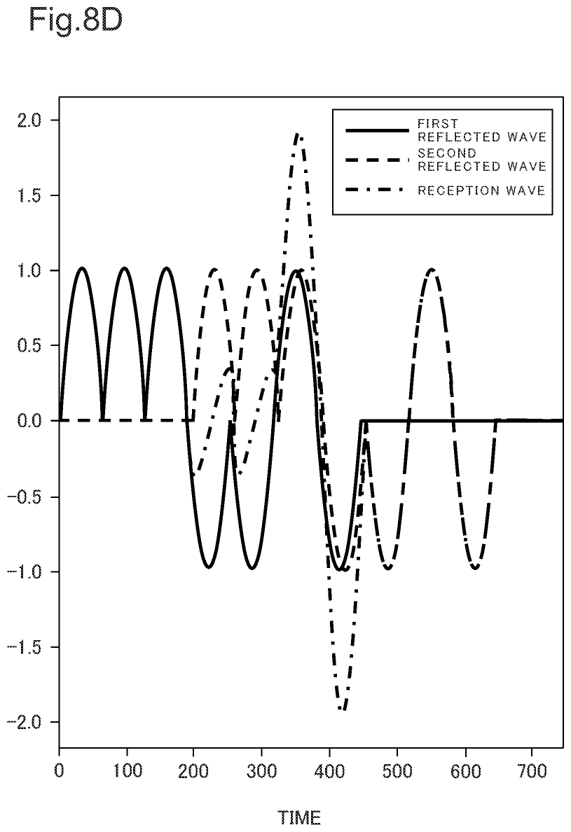

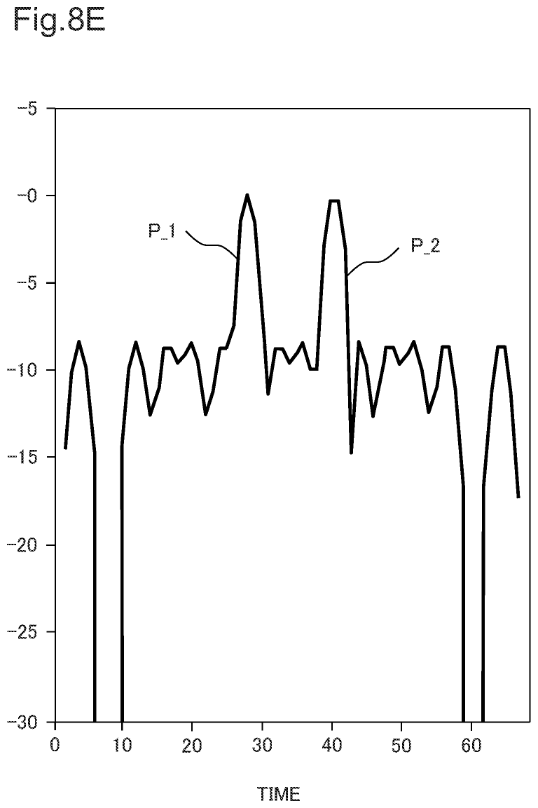

The pulse compression unit 22 acquires information indicating the first analog waveform from the modulation unit 21. Further, the pulse compression unit 22 acquires the reception signal from the reception unit 12. The pulse compression unit 22 executes pulse compression processing based on the first analog waveform and an analog waveform of the reception wave (hereinafter, may be referred to as a [second analog waveform]) by using the acquired information and signal. That is, the pulse compression unit 22 executes the pulse compression processing on the second analog waveform reflected by the object and received by the transmission/reception device 1 by using the first analog waveform. Herein, the second analog waveform corresponds to an analog waveform of an undetected reception signal. Hereinafter, the pulse compression processing based on the analog waveform of the undetected reception signal may be referred to as [analog pulse compression]. That is, the pulse compression unit 22 executes analog pulse compression. Specific examples of analog pulse compression are described later with reference to FIGS. 8A to 8E.

The distance estimation unit 23 estimates a distance D between the transmission/reception device 1 and each object, based on the result of the analog pulse compression. Specifically, for example, the distance estimation unit 23 acquires information indicating a time T1 at which the transmission unit 11 emits the transmission wave (i.e., the time at which the transmission/reception device 1 transmits the transmission wave). Further, the distance estimation unit 23 detects a time T2 for each peak portion in an analog waveform generated by analog pulse compression (hereinafter, may be referred to as an [analog pulse compression waveform]). The distance estimation unit 23 calculates a one-way propagation distance (D) based on the round-trip propagation time of the ranging wave for each peak portion (i.e., each object), based on a time difference ΔT between the times T1 and T2 and a value indicating a propagation speed V of the ranging wave in the air. For example, the distance estimation unit 23 calculates the one-way propagation distance (D) by using the following Equation (1).

$$D = ( V \times Δ T ) / 2 \qquad ( 1 )$$

In such a way, the distance D to each object is estimated. In other words, each object is detected.

Hereinafter, information indicating the distance D estimated by the distance estimation unit 23 may be referred to as [distance information]. Herein, it can be said that the distance information is information regarding each object detected by the object detecting device 2. Hereinafter, the information (including the distance information) regarding each object detected by the object detecting device 2 may be collectively referred to as [object detection information].

For example, the object detecting device 2 may include a position estimation unit (not illustrated) in addition to the distance estimation unit 23. The position estimation unit estimates the position of each object (more specifically, a position relative to the installation position of the transmission/reception device 1), based on the direction in which the transmission unit 11 emits the transmission wave (i.e., the direction in which the transmission/reception device 1 transmits the transmission wave) and the distance D estimated by the distance estimation unit 23. The object detection information may include, in addition to the distance information, information indicating the position of each object.

The output control unit 24 performs control for outputting the object detection information. The output device 3, which is described later, is used to output the object detection information. Specifically, for example, in a case where the output device 3 is a display device, the output control unit 24 executes control for causing the display device to display an image associated with the object detection information. Meanwhile, for example, in a case where the output device 3 is an audio output device, the output control unit 24 executes control for causing the audio output device to output audio associated with the object detection information. Accordingly, the user of the object detecting system 100 may visually or audibly recognize the distance D to each object, the position of each object, and the like.

Meanwhile, for example, in a case where the output device 3 is a communication device, the output control unit 24 executes control for causing the communication device to transmit a signal associated with the object detection information. Such a signal is transmitted to another system (not illustrated), for example. Accordingly, it is possible to notify the another system of the distance D to each object, the position of each object, and the like.

The output device 3 outputs the object detection information under the control of the output control unit 24. The output device 3 includes, for example, at least one of a display device, an audio output device, and a communication device. The display device includes, for example, a display. The audio output device includes, for example, a speaker. The communication device includes, for example, a dedicated transmitter and receiver.

Thus, the object detecting system 100 is configured.

Hereinafter, the transmission unit 11 may be referred to as a [transmission means]. Further, the reception unit 12 may be referred to as a [reception means]. The modulation unit 21 may be referred to as a [modulation means]. The pulse compression unit 22 may be referred to as a [pulse compression means]. The distance estimation unit 23 may be referred to as a [distance estimation means]. The output control unit 24 may be referred to as an [output control means].

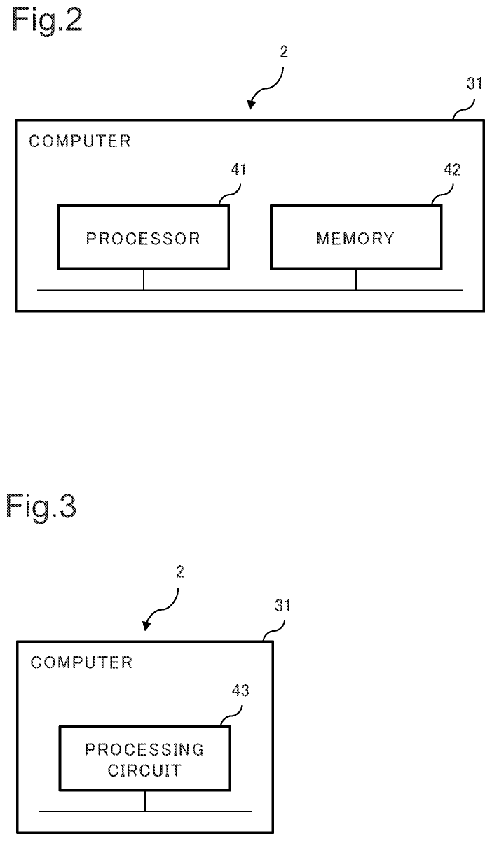

Next, the hardware configuration of the object detecting device 2 is described with reference to FIGS. 2 to 4.

As illustrated in FIGS. 2 to 4, the object detecting device 2 includes a computer 31.

As illustrated in FIG. 2, the computer 31 includes a processor 41 and a memory 42. The memory 42 stores a program for causing the computer 31 to function as the modulation unit 21, the pulse compression unit 22, the distance estimation unit 23, and the output control unit 24. The processor 41 reads and executes a program stored in the memory 42. Thus, a function F1 of the modulation unit 21, a function F2 of the pulse compression unit 22, a function F3 of the distance estimation unit 23, and a function F4 of the output control unit 24 are achieved.

Alternatively, as illustrated in FIG. 3, the computer 31 includes a processing circuit 43. The processing circuit 43 executes processing of causing the computer 31 to function as the modulation unit 21, the pulse compression unit 22, the distance estimation unit 23, and the output control unit 24. Thus, the functions F1 to F4 are achieved.

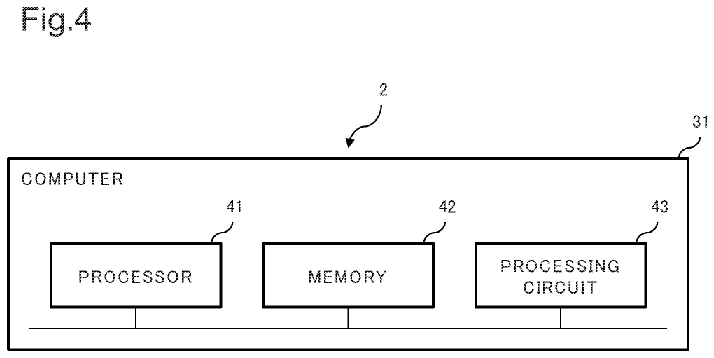

Alternatively, as illustrated in FIG. 4, the computer 31 includes a processor 41, a memory 42, and a processing circuit 43. In such a case, some of the functions F1 to F4 are achieved by the processor 41 and the memory 42, and the remaining functions of the functions F1 to F4 are achieved by the processing circuit 43.

The processor 41 is constituted of one or more processors. Each processor includes, for example, a central processing unit (CPU), a graphics processing unit (GPU), a microprocessor, a microcontroller, or a digital signal processor (DSP).

The memory 42 is constituted of one or more memories. Each memory includes, for example, a random access memory (RAM), a read only memory (ROM), a flash memory, an erasable programmable read only memory (EPROM), an electrically erasable programmable read only memory (EEPROM), a solid state drive, a hard disk drive, a flexible disk, a compact disk, a digital versatile disc (DVD), a Blu-ray disk, a magneto optical (MO) disk, or a mini disk.

The processing circuit 43 is constituted of one or more processing circuits. Each processing circuit includes, for example, an application specific integrated circuit (ASIC), a programmable logic device (PLD), a field programmable gate array (FPGA), a system on a chip (SoC), or a system large scale integration (LSI).

Note that the processor 41 may include a dedicated processor for each of the functions F1 to F4. The memory 42 may include a dedicated memory for each of the functions F1 to F4. The processing circuit 43 may include a dedicated processing circuit for each of the functions F1 to F4.

Next, an operation of the object detecting system 100 according to the first example embodiment is described. More specifically, the operation of the object detecting device 2 is mainly described with reference to the flowchart illustrated in FIG. 6.

First, the modulation unit 21 executes modulation processing on a transmission signal (step ST1). Specific examples of the modulation processing are described later with reference to FIGS. 6A, 6B, 7A, and 7B. Thus, the transmission unit 11 emits a transmission wave associated with the modulated transmission signal (i.e., a transmission wave having the first analog waveform). The emitted transmission wave is irradiated on each object and reflected by each object. The reception unit 12 receives the reflected wave. As a result, the reception signal is acquired.

Next, the pulse compression unit 22 executes pulse compression processing based on the analog waveform of the modulated transmission signal (i.e., the first analog waveform) and the analog waveform of the undetected reception signal (i.e., the second analog waveform) (step ST2). That is, the pulse compression unit 22 executes analog pulse compression. Specific examples of the analog pulse compression are described later with reference to FIGS. 8A to 8E.

Next, the distance estimation unit 23 estimates the distance D to each object, based on the result of the analog pulse compression (step ST3). Specifically, for example, the distance estimation unit 23 calculates the one-way propagation distance (D) for each peak portion in the analog pulse compression waveform by using the above-described Equation (1). Thus, the distance D is estimated.

Next, the output control unit 24 executes control for outputting the object detection information (step ST4). The object detection information includes information indicating the distance D estimated by the distance estimation unit 23 (i.e., distance information).

Next, a specific example of the modulation processing and a specific example of the first analog waveform are described with reference to FIGS. 6A, 6B, 7A, and 7B.

As described above, the modulation processing executed by the modulation unit 21 is modulation processing of converting the analog waveform of the transmission wave (i.e., the analog waveform of the transmission signal) into an analog waveform associated with a predetermined digital code string (i.e., the first analog waveform). In the first example embodiment, the predetermined digital code string includes binary codes using two values which are [−1] and [+1]. Specifically, for example, the predetermined digital code string uses a Barker code of N=7. Hereinafter, [j] may be used as a variable indicating each integer of 1 to N.

Herein, the Barker code is a finite code (Bⱼ) having a code length N, and is represented by the following Equation (2). Typically, the code length N of the Barker code is 2, 3, 4, 5, 7, 11 or 13. The autocorrelation function (Cᵥ) of the Barker code is represented by the following Equation (3).

$${B}_{j} = \pm 1 , ( j = 1 , 2 , … , N ) \qquad ( 2 )$$

$${C}_{v} = {\sum }_{j = 1}^{N - v} {B}_{j} {B}_{j + v} , \vert {C}_{v} \vert = \{ \begin{matrix}1 & 1 \leq v < N \\ N & v = 0\end{matrix} \qquad ( 3 )$$

The analog waveform of the transmission signal before modulation is, for example, a sine wave (see FIG. 6A). The modulation unit 21 executes predetermined phase modulation on such a waveform. Thus, for example, a first analog waveform associated with B=[+1, +1, +1, −1, −1, +1, −1], which is a Barker code of N=7, is generated (see FIGS. 6B and 7A). In other words, in the examples illustrated in FIGS. 6B and 7A, the s₊₁ of each upper convex portion in the first analog waveform (hereinafter, referred to as a [first portion] in the first example embodiment) is associated with [+1] being a first value in the binary code. Further, the s₋₁ of each lower convex portion in the first analog waveform (hereinafter, referred to as a [second portion] in the first example embodiment) is associated with [−1] being a second value in the binary code.

When a binary code is being used, the waveform of each first portion s₊₁ relates to the following Equation (4). Meanwhile, the waveform of each second portion s₋₁ relates to the following Equation (5). In other words, a waveform represented by Equation (4) is assigned to each [+1] code in the digital code string. Further, a waveform represented by Equation (5) is assigned to each [−1] code in the digital code string.

$${s}_{+ 1} = + sin ( 2 π t / Tm ) \qquad ( 4 )$$

$${s}_{- 1} = - sin ( 2 π t / Tm ) \qquad ( 5 )$$

Herein, Tm is a period relating to a modulation frequency in the modulation unit 21 (see FIGS. 6B and 7A). t is a section (more specifically, a half-open section) represented by the following Equation (6).

$$t = [ 0 , Tm / 2 ) \qquad ( 6 )$$

Herein, the first analog waveform preferably satisfies all of the following first condition, second condition, and third condition. In the examples illustrated in FIGS. 6B and 7A, the first analog waveform satisfies such conditions.

### <First Condition>

As a first condition, the shape and size of each first portion s₊₁ are equivalent to the shape and size of each second portion s₋₁. In other words, in the first analog waveform, each first portion s₊₁ is formed by inverting one second portion s₋₁ upside down. Meanwhile, in the first analog waveform, each second portion s₋₁ is formed by inverting one first portion s₊₁ upside down. Further, in the first analog waveform, the sum of the waveform of each first portion s₊₁ and the waveform of each second portion s₋₁ is 0 (see FIG. 7A). That is, a condition represented by the following Equation (7) is satisfied.

$${\int }_{0}^{T} {s}_{+ 1} ( t ) + {s}_{- 1} ( t ) d t = 0 \qquad ( 7 )$$

Herein, T is a period relating to the length of each first portion s₊₁ or each second portion s₋₁ in the first analog waveform (see FIGS. 6B and 7A). In other words, T is a period relating to the length of each code in a digital code string (e.g., a Barker code of N=7) associated with the first analog waveform.

### <Second Condition>

As a second condition, the period T in the first analog waveform is smaller than the period Tm relating to the modulation frequency (see FIGS. 6B and 7A).

### <Third Condition>

As a third condition, each first portion s₊₁ is always a positive value in the associated section [0, T). In other words, in the first analog waveform, the entire first portion s₊₁ is a positive value (see FIGS. 6B and 7A). Meanwhile, each second portion s₋₁ is always a negative value in the associated section [0, T). In other words, in the first analog waveform, the entire second portion s₋₁ is a negative value (see FIGS. 6B and 7A).

By satisfying such conditions, it is possible to sharpen a peak portion p in the analog waveform associated with the autocorrelation function of the first analog waveform (hereinafter, may be referred to as an [autocorrelation function waveform]) (see FIG. 7B). That is, the value of the peak portion p in the autocorrelation function waveform may be made sufficiently larger than the value of other portions in the autocorrelation function waveform. In addition, the width of the peak portion p in the autocorrelation function waveform may be sufficiently reduced. Hereinafter, such an autocorrelation function may be referred to as a [good autocorrelation function].

As described above, the modulation processing executed by the modulation unit 21 includes phase modulation for generating the first analog waveform. This processing differs from linear frequency modulation (LFM) commonly used in radars, LiDAR, or the like. Hereinafter, such modulation processing may be referred to as a [non-LFM modulation].

Next, specific examples of the analog pulse compression are described with reference to FIGS. 8A to 8E.

As described above, the pulse compression unit 22 executes pulse compression processing based on the analog waveform of the modulated transmission signal (i.e., the first analog waveform) and the analog waveform of the undetected reception signal (i.e., the second analog waveform). That is, the pulse compression unit 22 executes analog pulse compression. Specifically, for example, the pulse compression unit 22 executes convolution of the first analog waveform with respect to the second analog waveform.

Herein, as described above, the first analog waveform has a good autocorrelation function. Therefore, even in a case where a plurality of objects (for example, two objects) are arranged in proximity to each other in a line-of-sight direction, an analog waveform generated by convolution (i.e., an analog pulse compression waveform) has a peak portion for each object.

That is, when two objects are arranged in proximity to each other in the line-of-sight direction, the reception wave includes a component associated with a reflected wave from one of the two objects (hereinafter, may be referred to as a [first reflected wave]). Further, the reception wave includes a component associated with a reflected wave from the other one of the two objects (hereinafter, may be referred to as a [second reflected wave]). In other words, the reception wave is a wave acquired by mixing the first reflected wave and the second reflected wave.

At this time, the waveform of the reception wave is a waveform acquired by synthesizing the waveform of the first reflected wave and the waveform of the second reflected wave (see FIGS. 8A to 8D). Note that, a solid line in FIGS. 8A and 8D indicates a waveform of the first reflected wave. A broken line in FIGS. 8B and 8D indicates a waveform of the second reflected wave. The dashed-dotted line in FIGS. 8C and 8D indicates a waveform of the reception wave. Herein, as illustrated in FIGS. 8A and 8B, the waveforms of each of the first reflected wave and the second reflected wave are waveforms associated with the first analog waveform. Specifically, for example, each of the waveforms of the first reflected wave and the second reflected wave is a waveform in which the amplitude is reduced by attenuation such as a distance attenuation with respect to the first analog waveform.

Therefore, in the analog pulse compression waveform generated by the convolution as described above, a peak portion P_1 is generated based on the correlation between the transmission wave and a component of the reception wave being associated with the first reflected wave. Further, a peak portion P_2 is generated based on the correlation between the transmission wave and a component of the reception wave being associated with the second reflected wave (see FIG. 8E). At this time, since the first analog waveform has a good autocorrelation function, each of the peak portions P_1 and P_2 may be made sharp. As a result, the two peak portions P_1 and P_2 may be detected separately. In other words, the distance D to two associated objects may be estimated separately. As a result, the two objects may be detected separately.

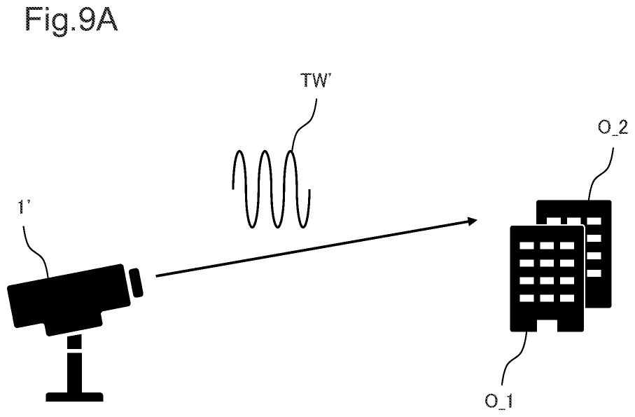

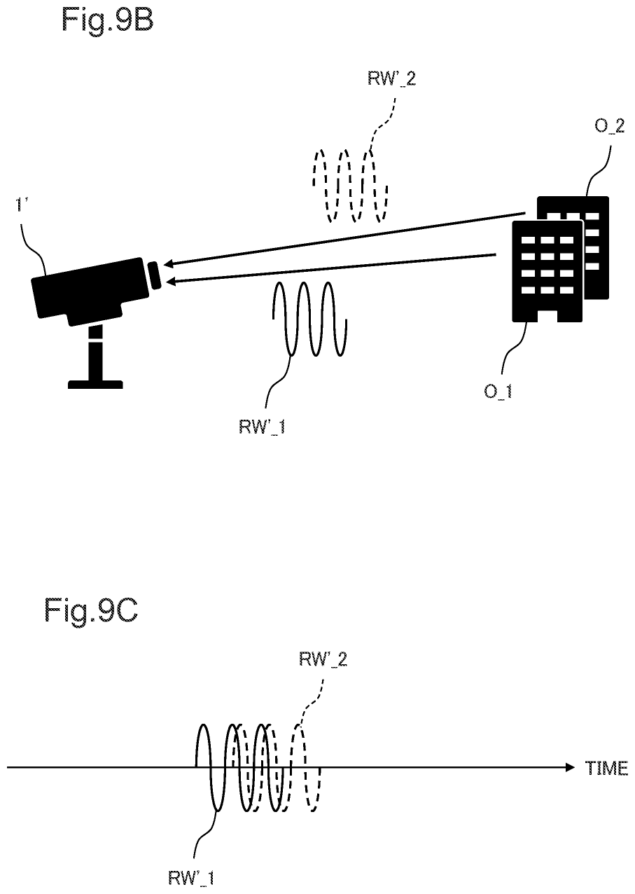

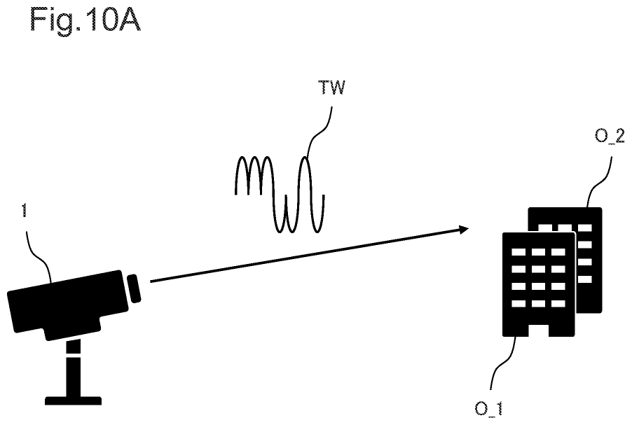

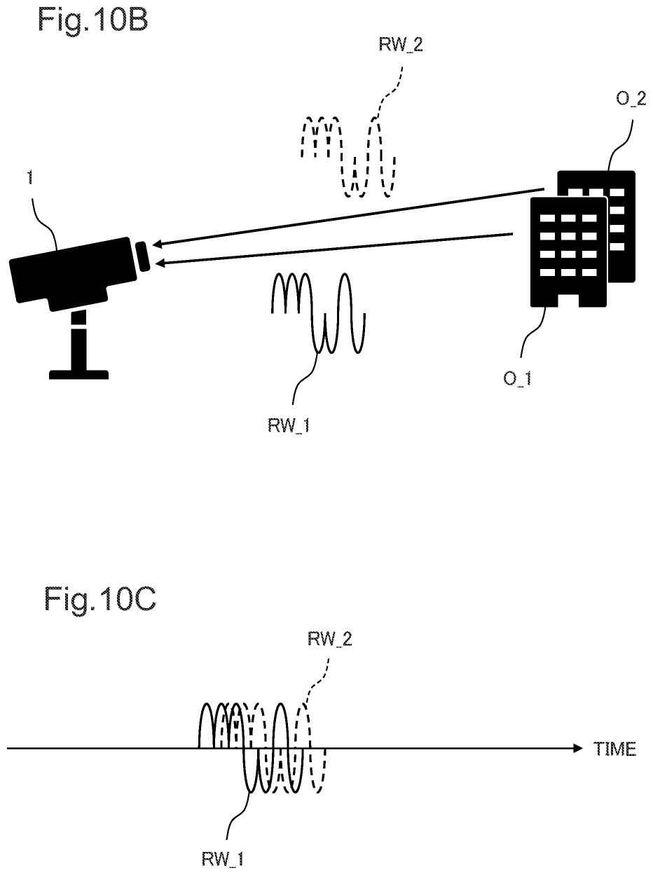

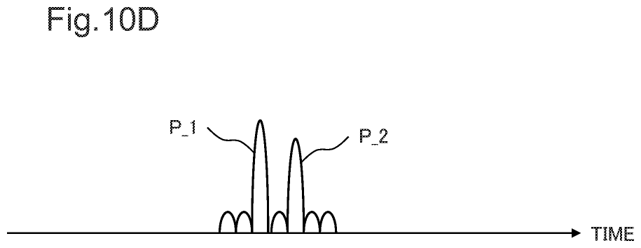

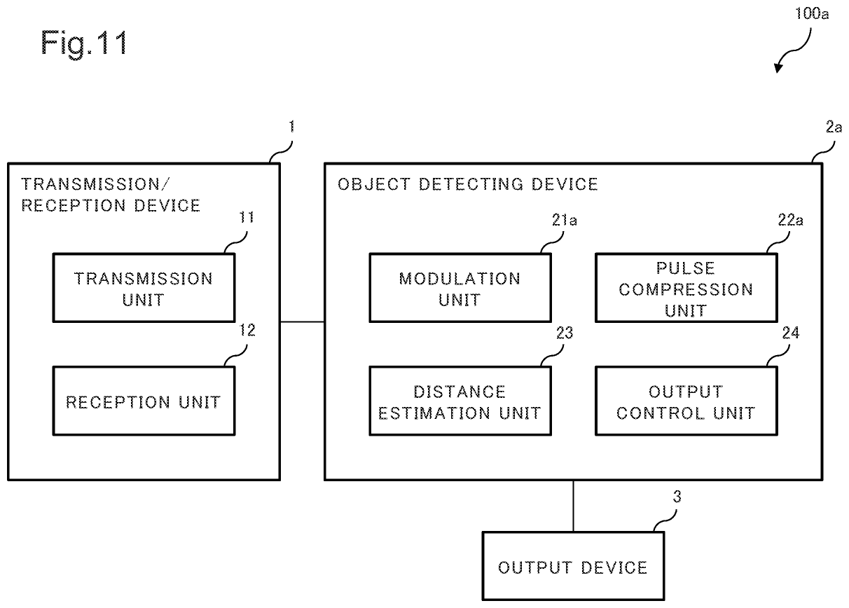

Next, with reference to FIGS. 9A to 9C, an example of object detection executed by an object detecting system 100′ for comparison to the object detecting system 100 is described. An example of object detection executed by the object detecting system 100 is described with reference to FIGS. 10A to 10D.

The object detecting system 100′ employs a conventional ToF method (i.e., a ToF method that does not use digital pulse compression and does not use analog pulse compression). The object detecting system 100′ includes a transmission/reception device l′ being similar to the transmission/reception device 1 (see FIGS. 9A and 9B).

As illustrated in FIG. 9A, the transmission/reception device 1′ transmits a transmission wave (TW′ in the figure). The analog waveform of the transmission wave in the transmission/reception device 1′ is similar to the analog waveform (for example, a sine wave) of the transmission wave before modulation in the transmission/reception device 1. The transmitted transmission wave is irradiated on each of two objects (O_1 and O_2 in the figure). The emitted transmission wave is reflected by each object. As illustrated in FIG. 9B, the transmission/reception device 1′ receives such reflected waves (RW′_1 and RW′_2 in the drawing). As a result, the reception signal is acquired.

Herein, the two objects O_1 and O_2 are arranged in proximity to each other in the line-of-sight direction. Therefore, the reception wave includes the reflected waves RW′_1 and RW′_2 associated with the two objects O_1 and O_2. More specifically, the reflected waves RW′_1 and RW′_2 of the reception wave overlap each other (see FIG. 9C). FIG. 9C illustrates a state in which the reflected waves RW′_1 and RW′_2 overlap each other. In such a case, in the object detecting system 100′ employing the conventional ToF method, it is difficult to distinguish and detect the component associated with the reflected wave RW′_1 and the component associated with the reflected wave RW′_2 in the received signal. Therefore, there is a problem that it is difficult to separately detect the two objects O_1 and O_2.

On the other hand, by using the object detecting system 100, as described above, the two objects O_1 and O_2 are able to be detected separately.

That is, as illustrated in FIG. 10A, the transmission/reception device 1 transmits a transmission wave (TW in the figure) having a first analog waveform. The transmitted transmission wave is irradiated on each of two objects (O_1 and O_2 in the figure). The emitted transmission waves are reflected by each object. As illustrated in FIG. 10B, the transmission/reception device 1 receives such reflected waves (RW_1 and RW_2 in the drawing) (see FIG. 10B). As a result, the reception signal is acquired.

Herein, the two objects O_1 and O_2 are arranged in proximity to each other in the line-of-sight direction. Therefore, the reception wave includes the reflected waves RW_1 and RW_2 associated with the two objects O_1 and O_2. More specifically, the reflected waves RW_1 and RW_2 overlap each other in the reception wave (see FIG. 10C). FIG. 10C illustrates a state in which the reflected waves RW_1 and RW_2 overlap each other. However, even in such a case, as described above, in the analog pulse compression waveform, two peak portions P_1 and P_2 associated with the two objects O_1 and O_2 are separately generated (see FIG. 10D). Therefore, the two objects O_1 and O_2 are able to be detected separately.

Next, a modification example of the object detecting system 100 is described.

The digital code string associated with the first analog waveform is not limited to a Barker code of N=7, and is not limited to a Barker code. The digital code string associated with the first analog waveform need only to have a good autocorrelation function. Herein, the digital code string associated with the first analog waveform is not limited to a binary code. In a second example embodiment described later, an example using a multi-bit code is described.

However, a Barker code has a particularly good autocorrelation function (hereinafter referred to as an [ideal autocorrelation function]) as compared with other binary codes (see Equation (3)). Therefore, by using a Barker code, the first analog waveform also has an ideal autocorrelation function (see FIG. 7B). Therefore, when a binary code is used, it is particularly preferable to use a Barker code.

Further, the first analog waveform is not limited to the specific example described above (i.e., the specific example illustrated in FIGS. 6B and 7A). The first analog waveform need only to include a first portion s₊₁ and a second portion s₋₁ associated with a predetermined digital code string. However, from the viewpoint of achieving a first analog waveform having a good autocorrelation function, it is preferable that the first analog waveform satisfies the first condition, the second condition, and the third condition as described above.

Next, effects of the object detecting system 100 are described.

As described above, the modulation unit 21 executes modulation processing of converting the analog waveform of the transmission wave sent toward the object (target object) from the transmission/reception device 1 into a first analog waveform being an analog waveform associated with a predetermined digital code string. The pulse compression unit 22 executes, by using the first analog waveform, pulse compression processing (analog pulse compression) on a second analog waveform being the analog waveform of the reception wave being reflected by the object (target object) and received by the transmission/reception device 1. The distance estimation unit 23 estimates a distance D between the transmission/reception device 1 and the object (target object).

As described above, the modulation unit 21 executes predetermined modulation processing (more specifically, non-LFM modulation), whereby the first analog waveform being used for analog pulse compression may be generated. The pulse compression unit 22 may execute analog pulse compression by using the generated first analog waveform. As described above, the analog pulse compression waveform has peak portions (for example, P_1 and P_2) for each object even in a case where a plurality of objects (for example, two objects O_1 and O_2) are disposed in proximity to each other in the line-of-sight direction. Therefore, even in such a case, the distance estimation unit 23 may estimate the distance D to each object, based on the result of the analog pulse compression.

That is, by using the analog pulse compression, even in a case where a plurality of objects (for example, two objects O_1 and O_2) are arranged in proximity to each other in the line-of-sight direction, the distance D to each object may be estimated. As a result, such objects are able to be detected separately. Herein, by using analog pulse compression, it is possible to avoid the occurrence of a decrease in distance resolution due to encoding (i.e., a decrease in distance resolution according to the value of d×c) in a case where digital pulse compression is used. Therefore, the distance resolution can be improved as compared with a case of using digital pulse compression.

Further, the first analog waveform includes a positive first portion s₊₁ and a negative second portion s₋₁ associated with each of the code values (+1, −1) in the digital code string. The period T relating to each of the first portion s₊₁ or the second portion s₋₁ in the first analog waveform is smaller than the period Tm relating to the modulation frequency in the modulation processing. Thus, it is possible to achieve the first analog waveform satisfying the second condition.

Further, the pulse compression processing includes processing of generating an analog pulse compression waveform having peak portions (P_1, P_2) for each of the objects (O_1, O_2) by executing convolution of the first analog waveform with respect to the second analog waveform. By executing such convolution, analog pulse compression may be achieved.

Further, information based on the result of the estimation by the distance estimation unit 23 (object detection information including distance information) is output. Thus, for example, it is possible to notify the user of the distance D estimated by the distance estimation unit 23. Alternatively, for example, the estimated distance D may be notified to another system.

Further, the digital code string is constituted of binary codes. Thus, a first analog waveform associated with a predetermined binary code (for example, B=[+1, +1, +1, −1, −1, +1, −1]) may be achieved.

Further, the transmission/reception device 1 is a LiDAR device. The transmission wave is laser light. Thus, the object detecting system 100 using LiDAR may be achieved.

### Second Example Embodiment

FIG. 11 is a block diagram illustrating an object detecting system according to a second example embodiment. An object detecting system according to the second example embodiment is described with reference to FIG. 11. Note that, in FIG. 11, a block similar to a block illustrated in FIG. 1 is denoted by the same reference sign, and description thereof is omitted.

As illustrated in FIG. 11, an object detecting system 100a includes a transmission/reception device 1, an object detecting device 2a, and an output device 3. The transmission/reception device 1 and the object detecting device 2a are connected to each other by wireless or wired communication. The object detecting device 2a and the output device 3 are connected to each other by wireless or wired communication. The object detecting device 2a includes a modulation unit 21a, a pulse compression unit 22a, a distance estimation unit 23, and an output control unit 24.

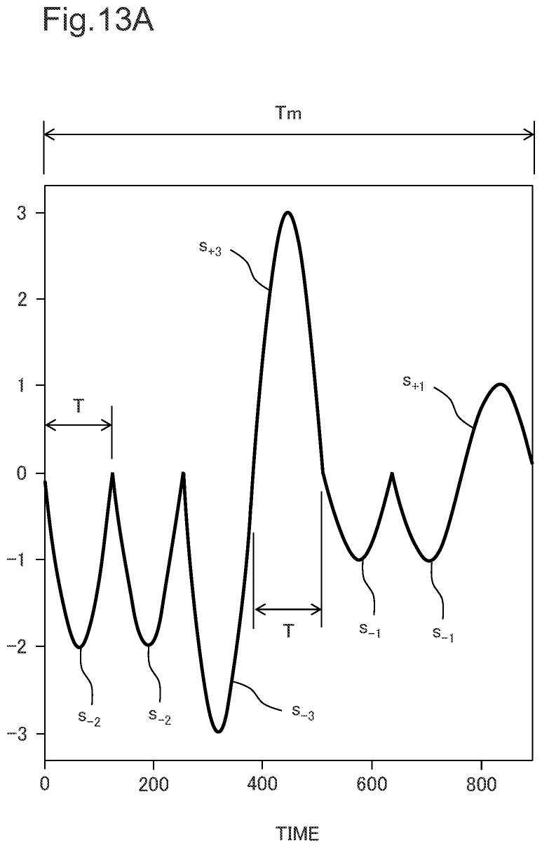

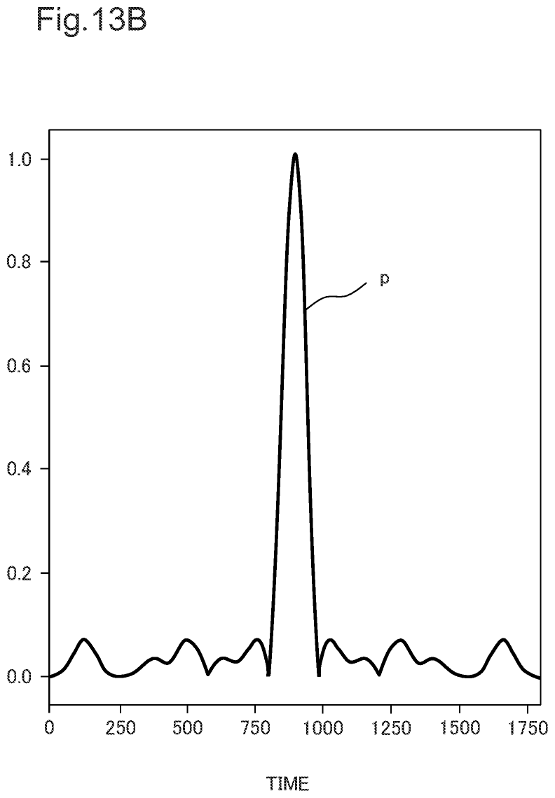

The modulation unit 21a executes modulation processing on the transmission signal. Herein, the modulation processing executed by the modulation unit 21a is modulation processing of converting an analog waveform of a transmission wave (i.e., an analog waveform of a transmission signal) into an analog waveform associated with a predetermined digital code string (i.e., a first analog waveform). In the second example embodiment, the predetermined digital code string includes a multi-bit code having a code length of N and including 2M values of −M to −1 and +1 to +M (i.e., a 2M-bit code). Herein, M is an integer of 2 or more. A specific example of the modulation process and a specific example of the first analog waveform are described later with reference to FIGS. 13A and 13B.

The pulse compression unit 22a executes analog pulse compression similar to the analog pulse compression executed by the pulse compression unit 22. That is, the pulse compression unit 22a executes pulse compression processing based on the analog waveform of the modulated transmission signal (i.e., the first analog waveform) and an analog waveform of an undetected reception signal (i.e., a second analog waveform). Specifically, for example, the pulse compression unit 22a executes convolution of the first analog waveform with respect to the second analog waveform. A waveform generated by such convolution (i.e., analog pulse compression waveform) is a waveform including a peak portion for each object.

In such a way, the object detecting system 100a is configured.

Hereinafter, the modulation unit 21a may be referred to as a [modulation means]. Further, the pulse compression unit 22a may be referred to as a [pulse compression means].

The hardware configuration of the object detecting device 2a is similar to the configuration described with reference to FIGS. 2 to 4 in the first example embodiment. Therefore, a detailed description thereof is omitted. That is, the object detecting device 2a includes a function F1a of the modulation unit 21a, a function F2a of the pulse compression unit 22a, a function F3 of the distance estimation unit 23, and a function F4 of the output control unit 24. Each of the functions F1a, F2a, F3, and F4 may be achieved by a processor 41 and a memory 42, or may be achieved by a processing circuit 43.

Herein, the processor 41 may include a dedicated processor for each of the functions F1a, F2a, F3, and F4. The memory 42 may include a dedicated memory for each of the functions F1a, F2a, F3, and F4. The processing circuit 43 may include a dedicated processing circuit for each of the functions F1a, F2a, F3, and F4.

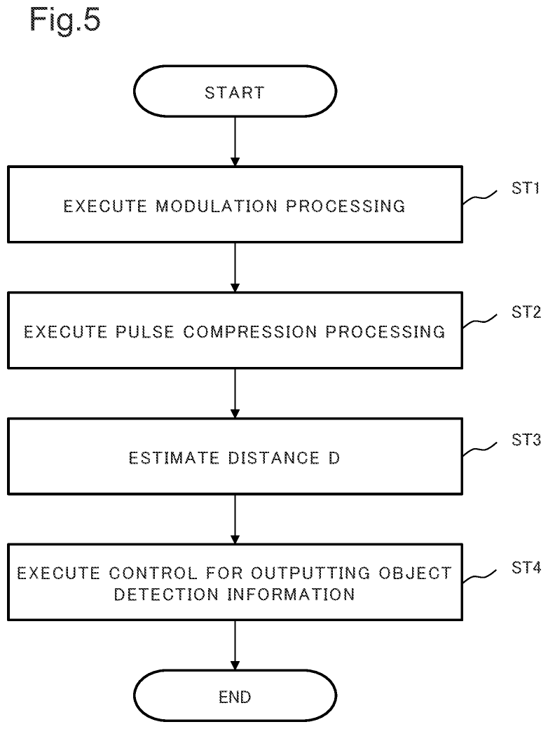

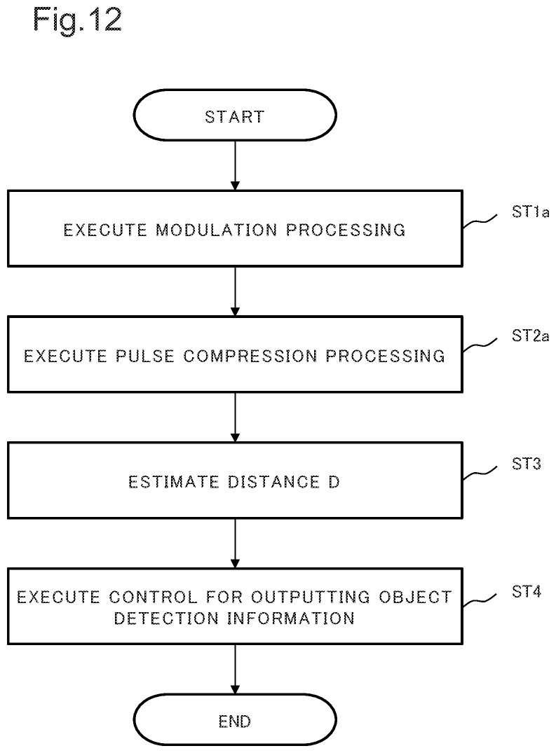

Next, an operation of the object detecting device 2a is described with reference to the flowchart illustrated in FIG. 12. Note that, in FIG. 12, steps similar to the steps illustrated in FIG. 5 are denoted by the same reference signal, and the description thereof is omitted.

First, the modulation unit 21a executes modulation processing on the transmission signal (step ST1a). Specific examples of the modulation processing are described later with reference to FIGS. 13A and 13B. Thus, the transmission unit 11 emits a transmission wave associated with the modulated transmission signal (i.e., a transmission wave having a first analog waveform). The emitted transmission waves are irradiated on each object and reflected by each object. The reception unit 12 receives the reflected wave. As a result, a reception signal is acquired.

Next, the pulse compression unit 22a executes pulse compression processing based on the analog waveform of the modulated transmission signal (i.e., the first analog waveform) and an analog waveform of an undetected reception signal (i.e., a second analog waveform) (step ST2a). That is, the pulse compression unit 22a executes analog pulse compression. As described above, the analog pulse compression executed by the pulse compression unit 22a is similar to the analog pulse compression executed by the pulse compression unit 22. Therefore, a detailed description thereof is omitted.

Then, processing of steps ST3 and ST4 are executed.

Next, a specific example of the modulation processing and a specific example of the first analog waveform are described with reference to FIGS. 13A and 13B.

As described above, the modulation processing executed by the modulation unit 21a is modulation processing of converting the analog waveform of the transmission wave (i.e., the analog waveform of the transmission signal) into an analog waveform associated with the predetermined digital code string (i.e., the first analog waveform). In the second example embodiment, the predetermined digital code string includes a multi-bit code having a code length of N and including 2M values of −M to −1 and +1 to +M (i.e., a 2M-bit code). Hereinafter, [i] may be used as a variable indicating each integer of 1 to M.

Herein, a multi-bit code (MBⱼ) constituting the digital code string is represented by the following Equation (8). An autocorrelation function (MCᵥ) of the multi-bit code (MBⱼ) is represented by the following Equation (9). The autocorrelation function (MCᵥ) satisfies a condition represented by the following In equation (10).

$${MB}_{j} = \pm 1 , \pm 2 , … , \pm M ( j = 1 , 2 , … , N ) \qquad ( 8 )$$

$${MC}_{v} = {\sum }_{j = 1}^{N - v} {MB}_{j} {MB}_{j + v} \qquad ( 9 )$$

$$\frac{{MC}_{0}}{max ( {MC}_{n} {\vert}_{1 \leq n < N} )} > N + 2 M \qquad ( 10 )$$

The first analog waveform includes an upper convex portion s₊ᵢ associated with each positive value [+i)] in the digital code string (hereinafter, referred to as a [first portion] in the second example embodiment). Further, the first analog waveform includes a lower convex portion s₋ᵢ associated with each negative value [−i] in the digital code string (hereinafter, referred to as a [second portion] in the second example embodiment).

When a multi-bit code is being used, the waveform of each first portion s₊ᵢ relates to the following Equation (11). Meanwhile, the waveform of each second portion s₋ᵢ relates to the following Equation (12). In other words, the waveforms represented by Equation (11) are assigned to each code of [+i] in the digital code string. Further, the waveform represented by Equation (12) is assigned to each code of [−i] in the digital code string.

$${s}_{+ i} = + i \times sin ( ω t ) {\vert}_{t = [ 0 , π / ω ]} \qquad ( 11 )$$

$${s}_{- i} = - i \times sin ( ω t ) {\vert}_{t = [ 0 , π / ω ]} \qquad ( 12 )$$

The analog waveform of the transmission signal before modulation is, for example, a sine wave. The modulation unit 21a executes predetermined amplitude phase modulation on such waveform. Thus, for example, a first analog waveform associated with MB=[−2, −2, −3, +3, −1, −1, +1], which is a digital code string of N=7 composed of M=3 multi-bit codes, is generated (see FIG. 13A).

Herein, the first analog waveform preferably satisfies all of the following first condition, second condition, and third condition. In the example illustrated in FIG. 13A, the first analog waveform satisfies such conditions. The first condition, the second condition, and the third condition in the second example embodiment correspond to the first condition, the second condition, and the third condition in the first example embodiment. However, the conditions in the second example embodiment are partially different from the conditions in the first example embodiment, due to the use of a multi-bit code instead of a binary code.

### <First Condition>

As a first condition, the shape and size of each first portion s₊ᵢ are equivalent to the shape and size of each second portion s₋ᵢ . In other words, in the first analog waveform, each first portion s₊ᵢ is formed by inverting one of the second portion s₋ᵢ upside down. Meanwhile, in the first analog waveform, each of the second portions s₋ᵢ is formed by inverting each of the first portions s₊ᵢ upside down. Further, in the first analog waveform, the sum of the waveform of each portion s₊ᵢ and the waveform of the second portion s₋ᵢ is 0 (see FIG. 13A). That is, a condition represented by the following Equation (13) holds.

$${\int }_{0}^{T} {s}_{+ i} ( t ) + {s}_{- i} ( t ) d t = 0 ( i = 1 , 2 , … , M ) \qquad ( 13 )$$

In addition, for any two values (k, 1) of −M to −1 or +1 to +M, the condition represented by the following Equation (14) holds. In a case where such values (k, 1) are selected from among −M to −1, the s₁ on the right side of Equation (14) is s₋₁. Meanwhile, when such values (k, 1) are selected from among +1 to +M, the s₁ on the right side of Equation (14) is s₊₁.

$${\int }_{0}^{T} {s}_{k} ( t ) + {s}_{l} ( t ) d t = ( k + l ) {\int }_{0}^{T} {s}_{1} ( t ) d t \qquad ( 14 )$$

Herein, the left side of Equation (14) represents an addition result of the waveforms in the first analog waveform for any two portions (sₖ, s₁) of the first portion s₊₁ to s₊M or the second portion s_{31 M} to s₋₁. Meanwhile, (k+1) on the right side of Equation (14) represents an addition result of the associated value (k, 1) in the digital code string. Therefore, Equation (14) indicates that the addition results are associated with each other.

### <Second Condition>

As a second condition, a period T of the first analog waveform is smaller than a period Tm relating to the modulation frequency (see FIG. 13A).

### <Third Condition>

As a third condition, each first portion s₊ᵢ is always a positive value in an associated section [0, T). In other words, in the first analog waveform, the entire first region s₊ᵢ is a positive value (see FIG. 13A). Meanwhile, each second portion s₋ᵢ is always a negative value in the associated section [0, T). In other words, in the first analog waveform, the entire second portion s₋ᵢ is a negative value (see FIG. 13A).

By satisfying these conditions, it is possible to sharpen the peak portion p in an autocorrelation function waveform associated with the first analog waveform (see FIG. 13B). That is, the value of the peak portion p in the autocorrelation function waveform may be made sufficiently larger than a value of another portion in the autocorrelation function waveform. In addition, the width of the peak portion p in the autocorrelation function waveform may be sufficiently reduced.

In other words, the first analog waveform has a good autocorrelation function. Therefore, even in a case where a plurality of objects (for example, two objects) are arranged in proximity to each other in the line-of-sight direction, an analog waveform generated by convolution (i.e., an analog pulse compression waveform) has a peak portion for each object. Thus, the distance D to each object may be estimated. As a result, such objects may be detected separately. This is as described in the first example embodiment.

As described above, the modulation processing executed by the modulation unit 21a includes amplitude phase modulation for generating the first analog waveform. This is a different process from the LFM conventionally used in a radar, a LiDAR, or the like. That is, the modulation processing executed by the modulation unit 21a is a non-LFM modulation.

Next, effects of the object detecting system 100a are described.

The object detecting system 100a has effects similar to those described in the first example embodiment. In addition, the object detecting system 100a has the following effects.

That is, the first analog waveform includes a positive first portion s₊ᵢ and a negative second portion s₋ᵢ associated with each of the code values (+i, −i) in the digital code string. The addition result (∫sₖ(t)+s₁(t)dt) of the waveform in the first analog waveform corresponds to the addition result of the associated code values in the digital code string (k+1) for any two portions (sₖ, s₁) in the first portion s₊₁ to s_{+M} or the second portion s_{-M} to s₋₁. Thus, it is possible to achieve the first analog waveform satisfying the first condition (more specifically, the condition represented by Equation (14)).

In addition, the digital code string is constituted of multi-bit codes. Thus, a first analog waveform associated with a predetermined multi-bit code (for example, MB=[−2, −2, −3, +3, −1, −1, +1]) may be achieved.

### Third Example Embodiment

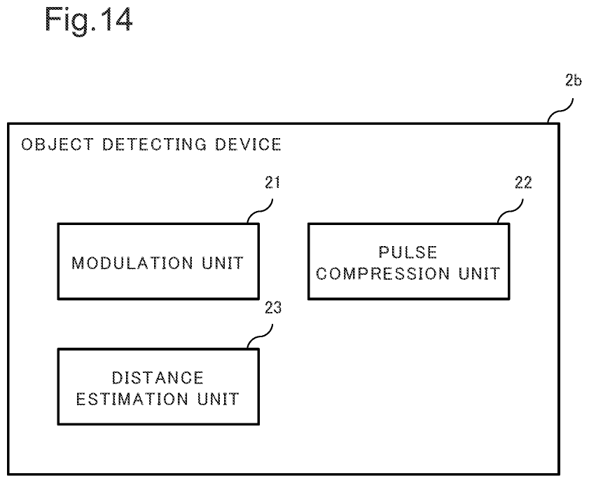

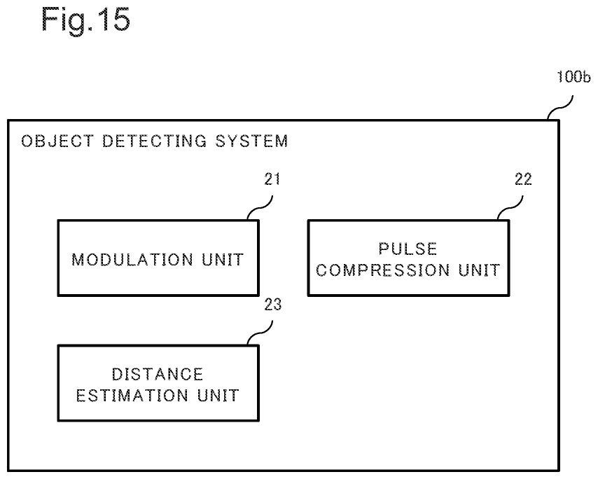

FIG. 14 is a block diagram illustrating an object detecting device according to a third example embodiment. The object detecting device according to the third example embodiment is described with reference to FIG. 14. FIG. 15 is a block diagram illustrating an object detecting system according to the third example embodiment. The object detecting system according to the third example embodiment is described with reference to FIG. 15. Note that, in each of FIGS. 14 and 15, a block similar to a block illustrated in FIG. 1 is denoted by the same reference signal, and description thereof is omitted.

Herein, the object detecting device according to each of the first and second example embodiments is one example of the object detecting device according to the third example embodiment. The object detecting system according to each of the first and second example embodiments is one example of the object detecting system according to the third example embodiment.

As illustrated in FIG. 14, an object detecting device 2b includes a modulation unit 21, a pulse compression unit 22, and a distance estimation unit 23. In other words, the modulation unit 21, the pulse compression unit 22, and the distance estimation unit 23 constitute the object detecting device 2b. In such a case, an output control unit 24 may be provided outside the object detecting device 2b.

As illustrated in FIG. 15, an object detecting system 100b includes a modulation unit 21, a pulse compression unit 22, and a distance estimation unit 23. In other words, the modulation unit 21, the pulse compression unit 22, and the distance estimation unit 23 constitute the object detecting system 100b. In such a case, a transmission/reception device 1 may be provided outside the object detecting system 100b. Further, an output control unit 24 may be provided outside the object detecting system 100b. Further, an output device 3 may be provided outside the object detecting system 100b.

Even in such cases, effects similar to those described in the first example embodiment may be acquired.

That is, the modulation unit 21 executes modulation processing of converting an analog waveform of a transmission wave sent toward an object (target object) by the transmission/reception device 1 into a first analog waveform being an analog waveform associated with a predetermined digital code string. The pulse compression unit 22 executes, by using the first analog waveform, pulse compression processing (analog pulse compression) on a second analog waveform being an analog waveform of a reception wave reflected by the object (target object) and received by the transmission/reception device 1. The distance estimation unit 23 estimates a distance D between the transmission/reception device 1 and the object (target object).

By using analog pulse compression, even in a case where a plurality of objects (for example, two objects O_1 and O_2) are arranged in proximity to each other in the line-of-sight direction, the distance D to each object may be estimated. As a result, the objects may be detected separately. Herein, by using analog pulse compression, it is possible to avoid the occurrence of a decrease in distance resolution due to encoding (i.e., a decrease in distance resolution according to the value of d×c) in a case where digital pulse compression is used. Therefore, the distance resolution may be improved as compared with a case of using digital pulse compression.

The object detecting device 2b may include a modulation unit 21a and a pulse compression unit 22a instead of the modulation unit 21 and the pulse compression unit 22. Further, the object detecting system 100b may include a modulation unit 21a and a pulse compression unit 22a instead of the modulation unit 21 and the pulse compression unit 22. Further, the object detecting system 100b may include an output control unit 24.

Herein, each unit of the object detecting system 100b may be constituted of an independent device. Such devices may be arranged geographically or networked in a distributed manner. Such devices may include, for example, an edge computer and a cloud computer.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Some or all of the above-described embodiments may be described as the following supplementary notes, but are not limited thereto.

### SUPPLEMENTARY NOTES

### Supplementary Note 1

An object detecting device including:
a modulation means for executing modulation processing of converting an analog waveform of a transmission wave being sent toward an object by a transmission/reception device into a first analog waveform being an analog waveform associated with a predetermined digital code string:
a pulse compression means for executing, by using the first analog waveform, pulse compression processing on a second analog waveform being an analog waveform of a reception wave reflected by the object and received by the transmission/reception device: and
a distance estimation means for estimating a distance between the transmission/reception device and the object, based on a result of the pulse compression processing.

### Supplementary Note 2

The object detecting device according to supplementary note 1, wherein
the first analog waveform includes a positive first portion and a negative second portion being associated with each code value in the digital code string, and
an addition result of waveforms in the first analog waveform is associated to an addition result of associated code values in the digital code string for any two portions in the first portion or the second portion.

### Supplementary Note 3

The object detecting device according to supplementary note 1, wherein
the first analog waveform includes a positive first portion and a negative second portion being associated with each code value in the digital code string, and
a period relating to each of the first portion or each of the second portion in the first analog waveform is smaller than a period relating to a modulation frequency in the modulation processing.

### Supplementary Note 4

The object detecting device according to any one of supplementary notes 1 to 3, wherein the pulse compression processing includes processing of generating an analog pulse compression waveform having a peak portion for each of the objects by executing convolution of the first analog waveform with respect to the second analog waveform.

### Supplementary Note 5

The object detecting device according to any one of supplementary notes 1 to 4, wherein information based on a result of estimation by the distance estimation means is output.

### Supplementary Note 6

The object detecting device according to any one of supplementary notes 1 to 5, wherein the digital code string is constituted of binary codes.

### Supplementary Note 7

The object detecting device according to any one of supplementary notes 1 to 6, wherein the digital code string is constituted of multi-bit codes.

### Supplementary Note 8

The object detecting device according to any one of supplementary notes 1 to 7, wherein
the transmission/reception device is a LiDAR device, and
the transmission wave is a laser beam.

### Supplementary Note 9

An object detecting system including:
a modulation means for executing modulation processing of converting an analog waveform of a transmission wave being sent toward an object by a transmission/reception device into a first analog waveform being an analog waveform associated with a predetermined digital code string:
a pulse compression means for executing, by using the first analog waveform, pulse compression processing on a second analog waveform being an analog waveform of a reception wave reflected by the object and received by the transmission/reception device; and
a distance estimation means for estimating a distance between the transmission/reception device and the object, based on a result of the pulse compression processing.

### Supplementary Note 10

The object detecting system according to supplementary note 9, wherein
the first analog waveform includes a positive first portion and a negative second portion being associated with each code value in the digital code string, and
an addition result of waveforms in the first analog waveform is associated to an addition result of associated code values in the digital code string for any two portions in the first portion or the second portion.

### Supplementary Note 11

The object detecting system according to supplementary note 9, wherein
the first analog waveform includes a positive first portion and a negative second portion being associated with each code in the digital code string, and
a period relating to each of the first portion or each of the second portion in the first analog waveform is smaller than a period relating to a modulation frequency in the modulation processing.

### Supplementary Note 12

The object detecting system according to any one of supplementary notes 9 to 11, wherein the pulse compression processing includes processing of generating an analog pulse compression waveform having a peak portion for each of the objects by executing convolution of the first analog waveform with respect to the second analog waveform.

### Supplementary Note 13

The object detecting system according to any one of supplementary notes 9 to 12, wherein information based on a result of estimation by the distance estimation means is output.

### Supplementary Note 14

The object detecting system according to any one of supplementary notes 9 to 13, wherein the digital code string is constituted of binary codes.

### Supplementary Note 15

The object detecting system according to any one of supplementary notes 9 to 13, wherein the digital code string is constituted of multi-bit codes.

### Supplementary Note 16

The object detecting system according to any one of supplementary notes 9 to 15, wherein
the transmission/reception device is a LiDAR device, and
the transmission wave is a laser beam.

### Supplementary Note 17

An object detecting method including:
executing, by a modulation means, modulation processing of converting an analog waveform of a transmission wave being sent toward an object by a transmission/reception device into a first analog waveform being an analog waveform associated with a predetermined digital code string;
executing, by a pulse compression means by using the first analog waveform, pulse compression processing on a second analog waveform being an analog waveform of a reception wave reflected by the object and received by the transmission/reception device; and
estimating, by a distance estimation means, a distance between the transmission/reception device and the object, based on a result of the pulse compression processing.

### Supplementary Note 18

The object detecting method according to supplementary note 17, wherein
the first analog waveform includes a positive first portion and a negative second portion being associated with each code value in the digital code string, and
an addition result of waveforms in the first analog waveform is associated to an addition result of associated code values in the digital code string for any two portions in the first portion or the second portion.

### Supplementary Note 19

The object detecting method according to supplementary note 17, wherein
the first analog waveform includes a positive first portion and a negative second portion being associated with each code in the digital code string, and
a period relating to each of the first portion or each of the second portion in the first analog waveform is smaller than a period relating to a modulation frequency in the modulation processing.

### Supplementary Note 20

The object detecting method according to any one of supplementary notes 17 to 19, wherein the pulse compression processing includes processing of generating an analog pulse compression waveform having a peak portion for each of the objects by executing convolution of the first analog waveform with respect to the second analog waveform.

### Supplementary Note 21

The object detecting method according to any one of supplementary notes 17 to 20, wherein information based on a result of estimation by the distance estimation means is output.

### Supplementary Note 22

The object detecting method according to any one of supplementary notes 17 to 21, wherein the digital code string is constituted of binary codes.

### Supplementary Note 23

The object detecting method according to any one of supplementary notes 17 to 21, wherein the digital code string is constituted of multi-bit codes.

### Supplementary Note 24

A recording medium recording a program for causing a computer to function as:
a modulation means for executing modulation processing of converting an analog waveform of a transmission wave being sent toward an object by a transmission/reception device into a first analog waveform being an analog waveform associated with a predetermined digital code string;
a pulse compression means for executing, by using the first analog waveform, pulse compression processing on a second analog waveform being an analog waveform of a reception wave reflected by the object and received by the transmission/reception device; and
a distance estimation means for estimating a distance between the transmission/reception device and the object, based on a result of the pulse compression processing.

### Supplementary Note 25

The recording medium according to supplementary note 24, wherein
the first analog waveform includes a positive first portion and a negative second portion being associated with each code value in the digital code string, and
an addition result of waveforms in the first analog waveform is associated to an addition result of associated code values in the digital code string for any two portions in the first portion or the second portion.

### Supplementary Note 26

The recording medium according to supplementary note 24, wherein
the first analog waveform includes a positive first portion and a negative second portion being associated with each code in the digital code string, and
a period relating to each of the first portion or each of the second portion in the first analog waveform is smaller than a period relating to a modulation frequency in the modulation processing.

### Supplementary Note 27

The recording medium according to any one of supplementary notes 24 to 26, wherein the pulse compression processing includes processing of generating an analog pulse compression waveform having a peak portion for each of the objects by executing convolution of the first analog waveform with respect to the second analog waveform.

### Supplementary Note 28

The recording medium according to any one of supplementary notes 24 to 27, wherein the program causes the computer to further function as an output control means for executing control for outputting information based on a result of estimation by the distance estimation means.

### Supplementary Note 29

The recording medium according to any one of supplementary notes 24 to 28, wherein the digital code string is constituted of binary codes.

### Supplementary Note 30

The recording medium according to any one of supplementary notes 24 to 28, wherein the digital code string is constituted of multi-bit codes.

### REFERENCE SIGNS LIST

1 Transmission/reception device

2, 2a, 2b Object detecting device

3 Output device

11 Transmission unit

12 Reception unit

21, 21a Modulation unit

22, 22a Pulse compression unit

23 Distance estimation unit

24 Output control unit

31 Computer

41 Processor

42 Memory

43 Processing circuit

100, 100a, 100b Object detecting system

What is claimed is:

1. An object detecting device comprising:
a modulator configured to execute modulation processing of converting an analog waveform of a transmission wave being sent toward an object by a transmission/reception device into a first analog waveform being an analog waveform associated with a predetermined digital code string;
a pulse compressor configured to execute, by using the first analog waveform, pulse compression processing on a second analog waveform being an analog waveform of a reception wave reflected by the object and received by the transmission/reception device; and
a distance estimator configured to estimate a distance between the transmission/reception device and the object, based on a result of the pulse compression processing.

2. The object detecting device according to claim 1, wherein
the first analog waveform includes a positive first portion and a negative second portion being associated with each code value in the digital code string, and
an addition result of waveforms in the first analog waveform is associated to an addition result of associated code values in the digital code string for any two portions in the first portion or the second portion.

3. The object detecting device according to claim 1, wherein
the first analog waveform includes a positive first portion and a negative second portion being associated with each code value in the digital code string, and
a period relating to each of the first portion or each of the second portion in the first analog waveform is smaller than a period relating to a modulation frequency in the modulation processing.

4. The object detecting device according to claim 1, wherein the pulse compression processing includes processing of generating an analog pulse compression waveform having a peak portion for each of the objects by executing convolution of the first analog waveform with respect to the second analog waveform.

5. The object detecting device according to claim 1, wherein information based on a result of estimation by the distance estimator is output.

6. The object detecting device according to claim 1, wherein the digital code string is constituted of binary codes.

7. The object detecting device according to claim 1, wherein the digital code string is constituted of multi-bit codes.

8. The object detecting device according to claim 1, wherein
the transmission/reception device is a LIDAR device, and
the transmission wave is a laser beam.

9. An object detecting system comprising:
a modulator configured to execute modulation processing of converting an analog waveform of a transmission wave being sent toward an object by a transmission/reception device into a first analog waveform being an analog waveform associated with a predetermined digital code string;
a pulse compressor configured to execute, by using the first analog waveform, pulse compression processing on a second analog waveform being an analog waveform of a reception wave reflected by the object and received by the transmission/reception device; and
a distance estimator configured to estimate a distance between the transmission/reception device and the object, based on a result of the pulse compression processing.

10. The object detecting system according to claim 9, wherein
the first analog waveform includes a positive first portion and a negative second portion being associated with each code value in the digital code string, and
an addition result of waveforms in the first analog waveform is associated to an addition result of associated code values in the digital code string for any two portions in the first portion or the second portion.

11. The object detecting system according to claim 9, wherein
the first analog waveform includes a positive first portion and a negative second portion being associated with each code values in the digital code string, and
a period relating to each of the first portion or each of the second portion in the first analog waveform is smaller than a period relating to a modulation frequency in the modulation processing.

12. The object detecting system according to claim 9, wherein the pulse compression processing includes processing of generating an analog pulse compression waveform having a peak portion for each of the objects by executing convolution of the first analog waveform with respect to the second analog waveform.

13. The object detecting system according to claim 9, wherein information based on a result of estimation by the distance estimator is output.

14. The object detecting system according to claim 9, wherein the digital code string is constituted of binary codes.

15. The object detecting system according to claim 9, wherein the digital code string is constituted of multi-bit codes.

16. The object detecting system according to claim 9, wherein
the transmission/reception device is a LIDAR device, and
the transmission wave is a laser beam.

17. An object detecting method comprising:
executing, by a modulator, modulation processing of converting an analog waveform of a transmission wave being sent toward an object by a transmission/reception device into a first analog waveform being an analog waveform associated with a predetermined digital code string;
executing, by a pulse compressor by using the first analog waveform, pulse compression processing on a second analog waveform being an analog waveform of a reception wave reflected by the object and received by the transmission/reception device; and
estimating, by a distance estimator, a distance between the transmission/reception device and the object, based on a result of the pulse compression processing.

18. The object detecting method according to claim 17, wherein
the first analog waveform includes a positive first portion and a negative second portion being associated with each code value in the digital code string, and
an addition result of waveforms in the first analog waveform is associated to an addition result of associated code values in the digital code string for any two portions in the first portion or the second portion.

19. The object detecting method according to claim 17, wherein
the first analog waveform includes a positive first portion and a negative second portion being associated with each code values in the digital code string, and
a period relating to each of the first portion or each of the second portion in the first analog waveform is smaller than a period relating to a modulation frequency in the modulation processing.

20. The object detecting method according to claim 17, wherein the pulse compression processing includes processing of generating an analog pulse compression waveform having a peak portion for each of the objects by executing convolution of the first analog waveform with respect to the second analog waveform.

21-23. (canceled)
